(19) United States
(12) Patent Application Publication
(10) Pub. No.: US 2010/0265035 A1
(43) Pub. Date: Oct. 21, 2010

(54) PROCESS TO SECURE KEYLESS ENTRY COMMUNICATIONS FOR MOTOR VEHICLES

(76) Inventor: Boris Ziller, Ratingen (DE)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 12/761,332

(22) Filed: Apr. 15, 2010

(30) Foreign Application Priority Data
Apr. 16, 2009 (DE) 10 2009 002 448.4

(51) Int. Cl. G06F 7/04

(52) U.S. Cl. 340/5.72

(57) ABSTRACT

Process to control access authorization for a motor vehicle. Using an activation circuit in the vehicle, a radio signal is sent out, and an ID transmitter which is carried by the user receives the radio signal and verifies it with an evaluation circuit. If verification is successful, the ID transmitter sends out a high frequency release signal which is received by the vehicle. The activation circuit activates an oscillating circuit so that the oscillation rise time of the oscillating circuit is varied in dependency of a randomly generated parameter, wherein the power supply of the oscillating circuit is controlled in dependency of the parameter. An expected system run time is determined using actual system run times, and included into the evaluation in order to prevent extensions of the radio distance.

### FIELD OF THE INVENTION

The invention concerns a process to improve the security of access control for Keyless Entry systems in motor vehicles.

### BACKGROUND OF THE INVENTION

Such Keyless Entry systems offer users of motor vehicles the option of obtaining access to a motor vehicle without mechanical lock operation. The user commonly carries a so called ID transmitter for this purpose, which enters into radio communication with the motor vehicle's systems. The triggering event for entering into such radio communication consists of the user approaching the motor vehicle, e.g. moving the hand towards the door area. When such an event is recorded, the vehicle's activation system or activation circuit sends out an activation radio signal which is received by an ID transmitter that is carried by the user. The activation radio signal is evaluated by the ID transmitter using a circuit; in particular, it is verified whether the activation radio signal originates from a vehicle that is assigned to the ID transmitter. This can be verified using a message that is encoded in the activation radio signal. In the event of successful verification in the ID transmitter, this ID transmitter sends out a high frequency release radio signal, which is received and decoded by the vehicle. Depending on the signal and if applicable, after further verifications of the signal, the vehicle releases the locking system so that the user can access the vehicle. Such communication is extremely rapid, so that the accessing user usually does not notice it if the access authorization is successfully verified. The door lock is usually already released as soon as the user actually reaches for it.

However, there are attacks on such forms of communication which are defined as relay station attacks. Access to a vehicle should commonly be granted only if the carrier of the ID transmitter is near the vehicle. While the radio distance between the ID transmitter and the motor vehicle is commonly limited to a few meters for this purpose, these attacks artificially and specifically lengthen the radio distance. When the radio distance is extended in this manner, the activation signal from the vehicle is received by an initial extension station and sent to a second station which is near the ID transmitter. In this manner, an unauthorized person can gain access to the vehicle if he is near the vehicle and the second radio station is located near the ID transmitter.

EP 06117688 describes a process which is intended to improve the security of such communication protocols.

However, there is still a need for protecting the security of Keyless Entry systems against such extensions of radio distances.

### SUMMARY OF THE INVENTION

The task of the invention therefore consists of providing an improved system to secure Keyless Entry systems.

The invention solves the task by means of a process to control access authorization for a motor vehicle with the attributes of Patent Claim 1.

In accordance with the invention, the activation circuit—in order to generate the activation radio signal—activates an oscillating circuit while controlling the power supply to the oscillating circuit so that the oscillation rise time of the oscillating circuit can be varied. Herein the oscillation rise time is varied depending on a randomly generated parameter by controlling the power supply. For instance, the duty cycle or duty factor is varied.

The oscillation rise time of the oscillating circuit can be varied between a minimal value that can be realized in practice and a maximum value. By lengthening the oscillation rise time, a time component which is subject to the control of the vehicle's circuits is consciously and specifically brought into the series of radio communications.

In a non-corrupted radio link (without a fraudulent radio distance extension), the system run time—that is, the time from starting to send the activation signal until the release signal is received, is comprised of several components. During a period T1, the oscillating circuit rises while activating the activation circuit until the response threshold of the receiving ID transmitter has been reached and sends out its activation signal to the ID transmitter. The ID transmitter receives this signal, verifies the information contained therein (e.g., a so called wake-up pattern) and sends a high frequency response signal back to the vehicle, wherein a time component T2 must be taken into account for receipt and verification. On the vehicle side, the high frequency release signal is received, verified and a release signal is sent to the mechanical locking device of the door lock, wherein a time component T3 is added.

Such an expected system run time is initially calculated in the invention with dependence on the generated random parameter. This calculated system run time results in a time window within which a response for releasing the door lock is expected in an uncorrupted connection without an extended radio distance.

The actually required time for sending out the radio signal and receiving the release signal—that is, the actual system run time—is measured and compared to the expected system run time. If the time deviates from the expected system run time by more than one specified parameter, the release of the locking system is blocked.

The invention is based on the knowledge that in the case of radio distance extension, the activation signal which is sent out was generated in dependency of the randomly generated parameter and therefore contains a specifically influenced time parameter. When the radio distance is extended, this extension component of the time will, however, occur a second time, namely in the extension of the radio distance to the ID transmitter. The activation signal is generated again there with another oscillating circuit, and passed on to the ID transmitter. The time component is then contained in the system run time twice, and the entire system run time then no longer matches the expected system run time. Therefore the response signal is not received within the time window which was calculated for receipt. The core of the invention therefore consists of the intended and artificial variation of the oscillation rise time of the activation circuit and the comparison of the expected system run time with the actual system run time.

Fundamentally, this concept is suitable for various frequencies of the activation signal, particularly for systems with a sending frequency of 20 kHz, but also for systems with a sending frequency of 125 kHz.

Herein it is significant that a known time share on the vehicle side is specifically included in the system run time, so that the system run time differs with every communication process for verifying the access authorization. An extended radio distance is not able to adjust to such a difference in the time delay from one case to the next. Fundamentally, instead of a randomly generated parameter, it is also possible to use another delay which is generated on the vehicle side using a different method. This can prevent delays in subsequent locking processes from being too similar due to a coincidence.

In order to influence the oscillation rise time of the oscillating circuit, the duty factor of the power supply can be influenced. However, other methods can also be used to change the transient response.

In a further development of the invention, the parameter which determines the delay in the transient response is sent to the ID transmitter. Alternatively, a value that is generated from the parameter can also be sent from the activation circuit to the ID transmitter. The ID transmitter then receives information about the oscillation rise time and can verify the consistency of various available data at that time. For instance, so called RSSI data, that is, data which are representative for the field intensity or receiving quality, can be used to determine the distance dependency of the ID transmitter from the vehicle and include this factor in the evaluation of the data.

In a further embodiment of the invention, communication between the ID transmitter and the vehicle's systems is performed in several segments.

In accordance with this embodiment of the invention, a message is first sent from the activation circuit in the vehicle to the ID transmitter. Depending on the message which was sent, the ID transmitter can adjust its response threshold for the following activation signal. In this manner, the security of the process can be further increased.

In a further embodiment, the activation circuit is laid out so that it is able to send at various frequencies. For instance, various channels at, e.g., 20 kHz, 22 kHz and 24 kHz can be provided for this purpose. The activation signal can be sent via these channels. The respective channel which will be used next can be encoded in a message and transmitted from the activation circuit to the ID transmitter. In the subsequent communication, the ID transmitter can them compare this to the channel specified in the previously transmitted message using the received frequency, thereby further increasing the security of the authentication process.

### BRIEF DESCRIPTION OF THE DRAWINGS

The invention will now be explained in further detail using a sample embodiment.

FIG. 1 shows a schematic overview of the arrangement of the components in the use of the process in accordance with the invention as in an initial embodiment.

### DETAILED DESCRIPTION OF THE INVENTION

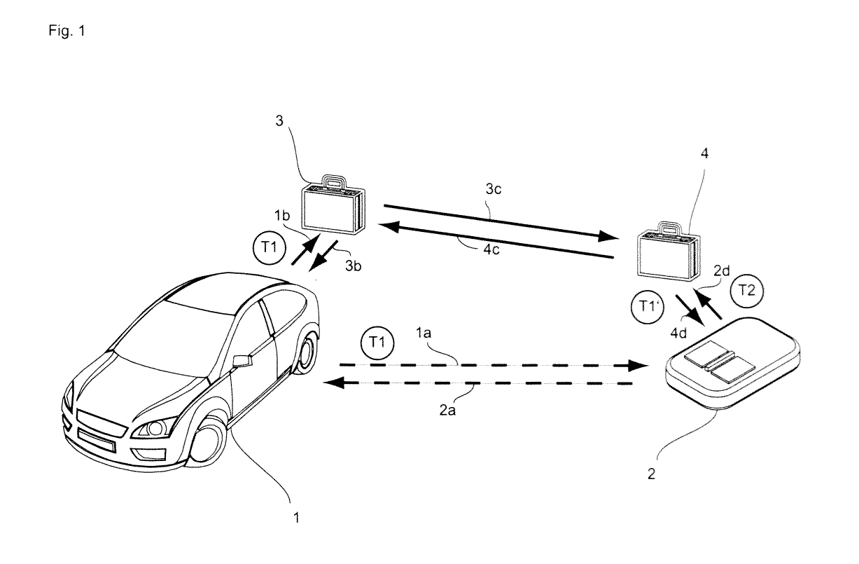

FIG. 1 shows a vehicle 1 which has a keyless entry access control system. An ID transmitter 2 is carried by a user and can execute radio communications with the vehicle 1 in order to verify the identification for access to the vehicle 1. When the user approaches the vehicle 1, particularly when a body part of the user approaches a vehicle handle, radio communication 1a, 2a is initiated by the vehicle 1 with the ID transmitter 2 to verify the identification of the accessing user. In particular, it is verified whether the ID that is stored in the ID transmitter is saved in the vehicle as an ID with access authorization.

The common and uncorrupted radio communication distance between vehicle 1 and the ID transmitter consists of several meters in the maximum case. It is to be ensured that the vehicle cannot be accessed when the user with the legitimating ID transmitter is excessively far from the vehicle, specifically out of sight range.

The relay station attack is carried out by artificially extending the radio distance between the vehicle 1 and the ID transmitter 2, so that the radio communications take place between the vehicle and the ID transmitter even though the distance between vehicle 1 and the ID transmitter 2 is actually so large that radio communication should not be possible based on the transmission output. For this purpose, an unauthorized attacker will place themselves in a location near vehicle 1 and use a system 3 which can be concealed, e.g., in a suitcase, to start an access attempt on the vehicle. A counter-station 4 is located with another attacker near the authorized user with the ID transmitter 2. The vehicle sends out its communication 1b which is directed to the ID transmitter 2. This is received by system 3 and transmitted to system 4 via another radio distance 3c. This system transmits the received message to the ID transmitter 2 in the form of message 4d. The ID transmitter 2 regards it as a message from vehicle 1 and sends out its identification verification and response. The response 2d from the ID transmitter 2 to the vehicle 1 again (4c, 3b) runs via the stations 4 and 3.

In terms of the invention, the vehicle's communication systems have an oscillating circuit which enters into an oscillation tuning process when the communication query is initiated. The oscillation rise time which the oscillating circuit requires to reach the response threshold of the ID transmitter is influenced on the vehicle side by specifying the duty cycle or duty factor. This makes it possible to exercise a specific influence on the delay of the oscillation tuning process. In accordance with the invention, delays between 1 and several 10 ms are possible. The oscillation rise time is adjusted depending on a random parameter that is generated by the vehicle systems. This random parameter can be linked with other vehicle systems in order to make it possible to generate a pseudo-random number from any sensor-determined vehicle parameter. All data which are available within the vehicle are suitable for this purpose, e.g., the kilometer reading, battery voltage, tire pressure or other parameters.

A pseudo-random figure which is generated in this manner provides values which cannot be traced or foreseen by an attacker.

When the process in accordance with the invention is initiated, the vehicle determines a delay by which the natural oscillation rise time of the oscillating circuit is lengthened. Using the duty factor of the oscillating circuit, the oscillation rise time is correspondingly influenced so that the response threshold of the communications with the ID transmitter is reached after a rise time T1 (in the figure, the messages 1a and 1b are associated with this time factor). If the ID transmitter is near the vehicle (message 1a), access is therefore authorized, the ID transmitter sends its response after evaluating and verifying the message immediately or with a slight delay T2. The response of the ID transmitter is transmitted to the vehicle's communication unit within the high frequency range, so that the entire system run time requires an acceptable time window around the oscillation rise time of the condenser plus the time T2 for the evaluation in the ID transmitter 2 and the high frequency response. If, for instance, an intentional delay T1 of 5 ms has been set, the accepted time window for a response from the ID transmitter will range between, e.g., 5 and 5.5 ms. Responses by the ID transmitter which lie outside this time window are ignored and do not lead to a release of the vehicle 1.

The vehicle generates an activation message 10 with 20 kHz for its communications with the ID transmitter. The ID transmitter receives this message 10, evaluates it and sends back a high frequency response signal 11. Since high frequency communications require a significantly shorter time, the time window must be correspondingly closely arranged around the specified oscillation rise time.

In an unauthorized access attempt, the system 3 receives the message 1b from the vehicle 1. The system 3 transmits the received message to the system 4 within the high frequency range. This normally requires a marginally relevant time period. In the transmission 4d from the station 4 to the ID transmitter 2, which must take place in the lower frequency range, the specified oscillation rise time T1′ now occurs; this was specified by the vehicle in dependency on a random parameter, since the condensers of the system are not charged at the start time. The time delayed message 1b is correspondingly transmitted to the ID transmitter with an approximately doubled delay as the message 4d.

The time delay factor which was intentionally inserted on the vehicle's side is therefore present in the system twice, so that the response 2d of the ID transmitter 2 is sent to the vehicle 1 with a delay. Now the response message from the ID transmitter 2 does not fall within the previously calculated time window; access to the vehicle is therefore denied.

Several variations are possible within the scope of the invention. In particular, numerous methods of determining the time delay parameter are possible. It can be randomly determined or derived from vehicle related parameters. It is significant that the invention can be implemented with common means which are generally already present, since—in particular—the oscillation rise time of the oscillating circuit can be adjusted via the duty cycle in the control unit, so that no significant structural adaptations are required.

I claim:

1. Process to control access authorization for a motor vehicle,
wherein an activation switch on the vehicle triggers an activation radio signal,
wherein an ID transmitter which is carried by a user of the motor vehicle receives the activation radio signal and verifies it with an evaluation circuit,
wherein, in the case of successful verification by the ID transmitter, a high frequency release radio signal is sent out,
wherein a control system in the vehicle receives the release radio signal and depending on the signal, triggers the release of a locking device on the vehicle, wherein
the activation circuit to generate the activation radio signal activates an oscillating circuit so that the oscillation rise time of the oscillating circuit is varied in dependency of a randomly generated parameter wherein the power supply of the oscillating circuit is controlled in dependency of the parameter,
an expected system run time is determined in dependency of the generated parameter, and
the duration from the activation of the oscillating circuit to the receipt of the release signal in the control unit is measured and compared to the expected system run time, wherein
the release of the locking system does not take place if the value varies by more than one specified parameter from the expected system run time.

2. Process in accordance with claim 1, wherein the parameter or a value generated out of the parameter is sent from the activation circuit to the ID transmitter.

3. Process in accordance with claim 1, wherein—prior to the transmission of the activation signal—a message is sent from the activation circuit to the ID transmitter, wherein the ID transmitter adjusts its response threshold for the activation signal depending on the message.
